(19) United States
(12) Patent Application Publication
(10) Pub. No.: US 2016/0344907 A1
(43) Pub. Date: Nov. 24, 2016

(54) Flexible Apparatus Including Photographing Module

(71) Applicant: BOUD CO. LTD, Seoul (KR)

(72) Inventor: Sung Ho Park, GYEONGGI-DO (KR)

(21) Appl. No.: 14/888,666

(22) PCT Filed: Aug. 28, 2015
(86) PCT No.: PCT/KR2015/009027

§ 371 Date: Nov. 2, 2015

(30) Foreign Application Priority Data
Jan. 23, 2015 (KR) 10-2015-0011314

(51) Int. Cl. H04N 5/225; G03B 15/03; G03B 13/36; G03B 17/14; H04N 5/232; G06F 3/16

(52) U.S. Cl. CPC H04N 5/2252; H04N 5/2257; H04N 5/23287; G06F 3/167; G03B 13/36; G03B 17/14; G03B 15/03

(57) ABSTRACT

Disclosed is a flexible apparatus with a photographing module. The flexible apparatus with the photographing module includes one or more photographing modules which photograph an image (including a still image and a moving image) of a subject; a storing module which stores one or more images photographed by the photographing module; a communication module which transmits the one or more images to an external device to display the one or more images photographed by the photographing modules on the external device; a control module which generates commands for driving the photographing module, the storing module, and the communication module; a flexible body which includes the photographing module, the storing module, the communication module, and the control module and is integrally formed, so that when force is applied, the flexible body is modified and the modified state is maintained even though the force is removed; and a housing which accommodates the photographing module, covers at least an upper surface of the photographing module to protect the photographing module, and is coupled to one end of the flexible body.

### TECHNICAL FIELD

The present invention relates to a photographing device, and more particularly, to a flexible apparatus which includes a photographing module and communicates with an external device.

### BACKGROUND ART

As an image sensor and an optical technique have been developed, an image quality of a camera is increased and a size of the camera is reduced.

Korean Unexamined Patent Application Publication No. 10-2005-0000663 discloses a camera device for a small portable terminal in which a lens having a zooming function is provided in a small portable terminal.

Recently, photo sharing through a social network service (SNS) becomes very popular in accordance with population of Internet and a high penetration rate of portable electronic equipment.

Specifically, daily life is shared with other people through an SNS such as Twitter, Facebook, and Instagram, so that interest in photographing and sharing various and stylish photos is increased.

As this phenomenon is reflected, “Selfie” which refers to a self-portrait photograph has been selected as a word of the year by Oxford in 2013.

That is, a photographing device which photographs a subject is changed from a simple photographing and storing medium to a medium for sharing photos.

Therefore, a demand of a photographing device which photographs a subject at various angles is present in the art.

Further, a demand of a photographing device which easily shares the photographed video is also present in the art.

### DISCLOSURE

### Technical Problem

An object to be solved by an exemplary embodiment of the present invention is to provide a flexible apparatus with a photographing module which has good portability and a photographing module which photographs a subject at various angles.

An object to be solved by another exemplary embodiment of the present invention is to provide a flexible apparatus with a photographing module which transmits a photographed image to an external device.

### Technical Solution

According to an exemplary embodiment of the present invention, a flexible apparatus with a photographing module is disclosed. The flexible apparatus with the photographing module includes one or more photographing modules which photograph an image (including a still image and a moving image) of a subject; a storing module which stores one or more images photographed by the photographing module; a communication module which transmits the one or more images to an external device to display the one or more images photographed by the photographing modules on the external device; a control module which generates commands for driving the photographing module, the storing module, and the communication module; a flexible body which includes the photographing module, the storing module, the communication module, and the control module and is integrally formed, so that when force is applied, the flexible body is modified and the modified state is maintained even though the force is removed; and a housing which accommodates the photographing module, covers at least an upper surface of the photographing module to protect the photographing module, and is coupled to one end of the flexible body.

### Advantageous Effects

A flexible apparatus with a photographing module according to the present invention may have excellent portability and photograph a subject at various angles. A flexible apparatus with a photographing module according to the present invention may transmit a photographed image to an external device.

### DESCRIPTION OF DRAWINGS

Now, various aspects will be described with reference to the drawings and like reference numerals collectively designate like elements. In the following exemplary embodiments, for the purpose of description, various specific details are suggested to provide overall understanding of one or more aspects. However, it is obvious that the aspects may be embodied without having the specific details. In other examples, known structures and devices are illustrated in block diagrams in order to easily describe one or more aspects.

FIG. 1 is a block diagram illustrating a configuration of a flexible apparatus with a photographing module according to an exemplary embodiment of the present invention.

FIG. 2A illustrates a flexible apparatus with a photographing module according to an exemplary embodiment of the present invention.

FIG. 2B illustrates a flexible apparatus with a photographing module according to an exemplary embodiment of the present invention and a detachable housing.

FIG. 3A illustrates an exemplary shape of a rotating operation of a flexible apparatus with a photographing module according to an exemplary embodiment of the present invention.

FIG. 3B illustrates an exemplary shape of a rotating operation of a flexible apparatus with a photographing module according to another exemplary embodiment of the present invention.

FIG. 4 illustrates an exemplary shape of a bending operation of a flexible apparatus with a photographing module according to an exemplary embodiment of the present invention.

FIG. 5 illustrates a flexible apparatus with a photographing module according to an exemplary embodiment of the present invention which is put on the wrist.

### BEST MODE

Various exemplary embodiments and/or aspects will be disclosed with reference to the drawings. In the following description, for the purpose of description, various specific details are disclosed to provide overall understanding of one or more aspects. However, those skilled in the art may understand that the aspect(s) may be embodied without having the specific details. The following description and accompanying drawings thoroughly describe specific exemplary aspects of one or more aspects. However, the aspects are provided for an illustrative purpose, some of various methods in principles of the various aspects may be used, and the description is intended to include the aspects and equivalents thereof.

The “exemplary embodiment”, “example”, and “aspect” used in this specification may not be interpreted that a described arbitrary aspect or design is better than or more advantageous than other aspects or designs.

Further, it is intended that a terminology “or” refers to not exclusive “or” but implicational “or”. That is, if it is not specifically designated or unclear in the context, “X uses A or B” is intended to refer to one of natural implicational substitutions. In other words, when “X uses A”, “X uses B”, or “X uses both A and B”, “X uses A or B” may be applied to any case. Further, it should be understood that a terminology “and/or” used in the specification indicates and includes all possible combinations of one or more items among related listed items.

It should be understood that the terminology of “comprise” and/or “comprising” means existence of the features and/or constituent elements but does not exclude the existence or addition of one or more other features, constituent elements, and a group thoseof. Further, unless particularly stated otherwise in the present specification, a singular form may be generally interpreted to mean “one or more” in the specification and claims.

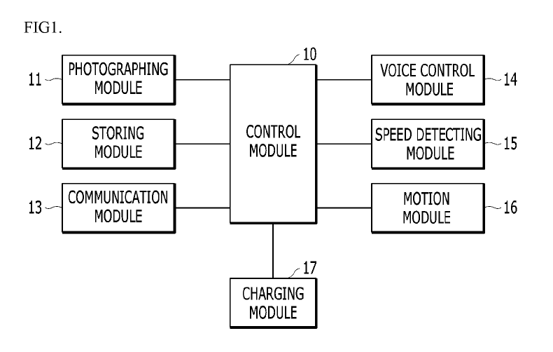

FIG. 1 is a block diagram illustrating a configuration of a flexible apparatus with a photographing module according to an exemplary embodiment of the present invention.

As illustrated in the drawing, a flexible apparatus with a photographing module may include a control module 10, a photographing module 11, a storing module 12, and a communication module 13. Additionally, the flexible apparatus may further include a voice control module 14, a speed detecting module 15, a motion module 16, and a charging module 17.

Individual modules illustrated in FIG. 1 are merely examples according to one aspect of the present invention so that additional variable, module, and a combination thereof may fall within the scope of the present invention.

Hereinafter, individual modules will be described.

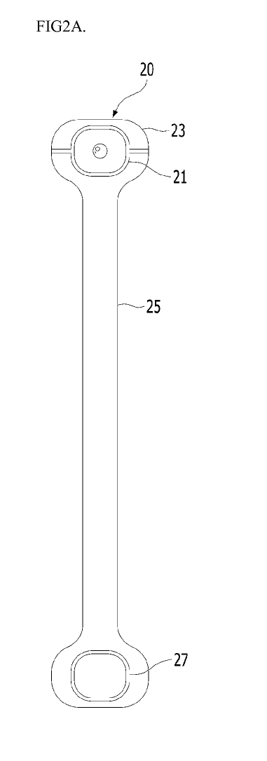

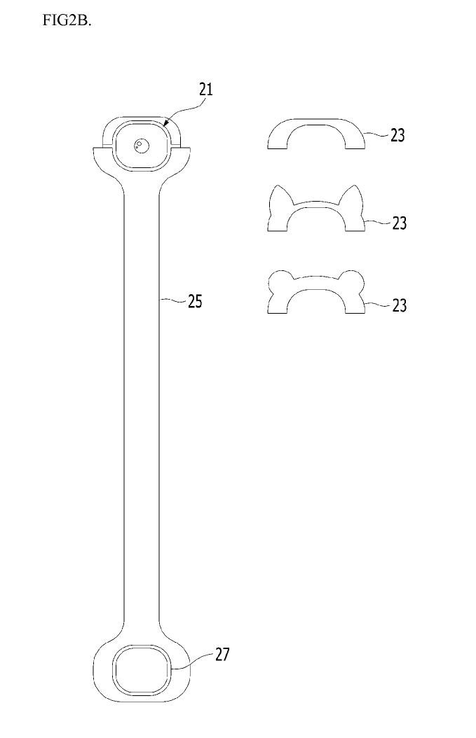

The flexible apparatus may photograph an image, which may include a still image and a moving image, of a subject through the photographing module 11. According to one aspect of the present invention, at least one camera may be selected as the photographing module 11. Alternatively, at least one camcorder may be selected as the photographing module 11. The photographing module 11 may be formed at one end of a flexible body 25 (see FIG. 2), which will be described below with reference to FIG. 2.

The photographing module 11 may further include an optical image stabilizer (OIS) module which automatically adjusts a focus by moving a lens similar to eyes of a human being in accordance with movement of the camera. The OIS means optical hand shaking compensation. As compared with an electronic hand shaking compensation which requires a plurality of frame images to detect motion, the OIS may compensate hand shaking using just one frame image.

The photographing module 11 according to additional exemplary embodiment may further include an auto focus actuator (AFA) module for focus adjustment. The AFA means an automatic focus device. Therefore, the photographing module 11 changes a position of the lens through the AFA module to adjust a focus and thus clearly photographs the subject. At least one of an encode method, a piezo method, and a voice coil motor (VCM) method may be employed for the AFA module.

Further, the photographing module 11 may further include a flash module (not illustrated) which emits light in order to illuminate surroundings when an image is photographed through the photographing module. The flash module may be disposed at one side of the camera or camcorder which is selected as the photographing module 11.

Additionally, one or more LEDs may be employed as the flash module. For example, two LEDs (for example, a dual LED) may be employed as the flash module. Furthermore, the flash module may further include at least one of a polarized light filter (PL filter) and a circular polarization light filter (CPL filter) which helps even light emission distribution of the flash. Further, a reflective plate may be provided instead of the flash module. The light is reflected onto the subject by the reflective plate to appropriately expose the subject.

Further, the photographing module 11 may have at least one function of an ISO adjusting function, a resolution adjusting function, an out-focus function, a mechanical shutter, and a zooming function.

International standards organization (ISO) is an international standard terminology that indicates reactivity with respect to light. As the number of ISO is increased, a response speed of the light is increased.

ISO may be selected by a user. For example, when a user photographs a portrait photo during the day time, ISO 100 may be selected. Further, ISO 400 may be selected for an indoor photograph. Furthermore, the ISO may be automatically adjusted by the control module 10.

A resolution indicates the number of entire pixels as a criterion indicating how many pixels are included in one image. The unit of the resolution is pixel per inch (ppi) and a dot per inch (dpi). For example, in the case of 150 dpi, 150 pixels are included in one inch in width and length. Therefore, as the number of pixels included in one inch is increased, a high quality and clear image may be obtained.

According to an exemplary embodiment of the present invention, the resolution of the photographing module 11 may be variously adjusted. The resolution may be selected by the user. Alternatively, the resolution may be automatically adjusted by the control module 10. For example, when a space of the storing module 12 is not sufficient, the resolution may be automatically adjusted to be a low resolution.

Moreover, out of focus refers to a function of photographing an image by adjusting a focus on a desired portion of the subject through a selective focus function, that is, the out of focus function. Accordingly, according to an aspect of the present invention, the focus is adjusted to a desired part of the subject, so that the background is photographed to be blurred and the subject is clearly photographed.

Additionally, the photographing module 11 may include a mechanical shutter. Moreover, the photographing module 11 may include an electronic shutter. The mechanical shutter and the electronic shutter may be provided together, so that a shutter mode which is suitable for an image type to be photographed may be used. For example, the electronic shutter may be selected for a high speed continuous photography of 10 fps (fps is an abbreviation of frame per second (the number of frames for a second) or more. Further, the mechanical shutter may be provided for general photography.

Moreover, the photographing module 11 includes the zooming module to photograph a subject which is far away.

According to the exemplary embodiment of the present invention, one or more images which are photographed by the photographing module 11 may be stored through the storing module 12. At least one of a flash memory type, an SD memory, an XD memory, a magnetic memory, and a magnetic disc may be employed as the storing module 12.

In one aspect of the present invention, the one or more images photographed by the photographing module 11 may be transmitted to external devices through the communication module 13. To this end, the communication module 13 may include a wireless communication module for network connection.

According to an exemplary embodiment of the present invention, a wireless LAN (WLAN: Wi-Fi), wireless broadband (Wibro), world interoperability for microwave access (Wimax), and high speed downlink packet access (HSDPA) may be used for a wireless communication technique.

Further, the communication module 13 may include a short range communication module to transmit/receive data to/from an electronic device including a short range communication module. Near field communication (NFC), Bluetooth, radio frequency identification (RFID), infrared data association (IrDA), ultra wideband (UWB), and ZigBee may be used for a short range communication technique.

Furthermore, the communication module 13 may further include a wired communication module. A digital subscriber line (XDSL), fibers to the home (FTTH), and power line communication (PLC) may be used for a wired communication technique.

By doing this, one or more images which are photographed by the photographing module 11 may be stored in a memory module of an external device which communicates with the flexible apparatus 20 with a photographing module. Further, the flexible apparatus according to an aspect of the present invention may include the storing module 12, so that the image photographed by the photographing module 11 is stored in the storing module 12.

The above-described memory module may include at least one of a flash memory type, a hard disk type, a multimedia card micro type, a card type memory (for example, SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

Further, the one or more images photographed by the photographing module 11 may be stored in a web storage which performs a storing function on the Internet.

The communication module 13 according to the exemplary embodiment of the present invention may transmit the one or more images to the external device so that the one or more images photographed by the photographing module 11 may be displayed on an external device which may communicate with the flexible apparatus 20 with a photographing module.

Additionally, the flexible apparatus 20 with a photographing module may further include a converting module (not illustrated) to change a format of the stored image file to a file format to be displayed on the external device.

Further, one or more images which are photographed by the photographing module 11 may be transmitted to the external device through the communication module 13 to be streamed by the external device.

Further, one or more images which are photographed by the photographing module 11 may be transmitted to at least one of an external device and an external server which are automatically determined in advance in the unit of a predetermined period which is determined by the communication module 13 and the control module 10. The predetermined period and the predetermined external device and external server may be changed by the user. For example, the one or more images which are photographed by the photographing module 11 may be automatically transmitted to the external device once a week.

Alternatively, the image which is photographed by the photographing module 11 may be uploaded to a predetermined account. For example, one or more images which are photographed by the photographing module 11 may be directly uploaded to the predetermined account through the communication module 13 by interworking with an account of a social network service.

The control module 10 according to an exemplary embodiment of the present invention may create commands for driving the photographing module 11, the storing module 12, and the communication module 13.

That is, the control module 10 may control overall operations of the flexible apparatus 20 with a photographing module.

According to additional exemplary embodiment of the present invention, the photographing module 11 may be controlled by the control module 10. By doing this, the photographing module 11 may perform continuous photographing, panoramic photographing, surround photographing, three-dimensional stereography, and close-up photographing.

The continuous photographing is a function of continuously photographing images. Therefore, the continuous photographing is effective to photograph a running child or various facial expressions. For the continuous photographing, a predetermined speed and a predetermined number of continuous photographing may be set. Additionally, there may be a plurality of predetermined speeds and a plurality of predetermined numbers of continuous photographing, so that the user may select therefrom. Alternatively, the continuous photographing may be performed at a predetermined speed until the user stops photographing.

Further, the focus may be automatically and continuously adjusted by the AFA module while performing the continuous photographing. Even though the flash module may be used together, it takes time to charge the flash so that the speed of the continuous photographing may be slower.

The panoramic photographing is a technique which photographs the 360 degree views by several images and then assembles the several photographed images into one wide image which can be seen at a glance because 360 degree views cannot be photographed in one image.

The surround photographing is a function which photographs a subject while moving a camera in four directions (up and down and left and right) rather than one direction.

The three-dimensional stereography is a technique which photographs a subject by lenses in different positions at one time. To this end, a separate image processor which receives and combines two images may be provided.

The close-up photographing is a technique which approaches the subject to photograph the subject and captures the subject at the shortest distance where the camera lens is closest to the subject.

According to the exemplary embodiment of the present invention, the control module 10 may store at least one image which is photographed by at least one photographing module 11 in the storing module 12, which may be understood when the above-described content is referenced.

According to an additional exemplary embodiment of the present invention, the control module 10 may further include the voice control module 14. That is, a voice command signal is detected in accordance with a voice command which is set in advance by the voice control module 14 and the modules may be driven in accordance with the detected voice command. For reference, a voice command which is set by a voice input unit which is provided in at least one of the photographing module 11 and the external device is referred to as a “predetermined voice command”.

That is, a voice command such as “photograph”, “store”, and “transmit” is set and an operation corresponding to the set voice command, for example, a “photographing operation”, a “storing operation”, and a “transmitting operation” may be performed. To this end, a known speech recognition technology may be used.

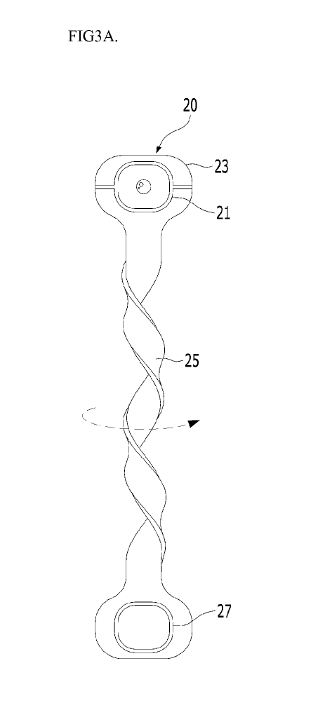

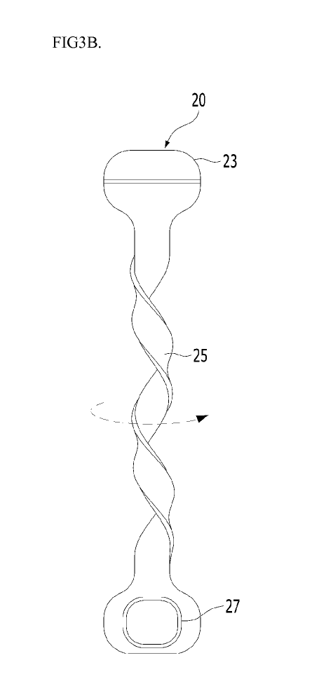

Further, the control module 10 may further include the motion module 14. The flexible body may perform at least one of a bending operation and a rotating operation by the motion module 14. Furthermore, an operating direction, an operating speed, and the photographing module may be controlled by the motion module 14, which will be described below with reference to FIGS. 3, 4, and 5.

According to the exemplary embodiment of the present invention, the control module 10 may further include a speed detecting module 15. A speed of the subject may be detected by the speed detecting module 15. Furthermore, a lens and the photographing module may be automatically adjusted in accordance with the speed of the subject.

Further, the control module 10 may further include a key input unit which receives a user input (for example, photograph, transmit, and store) to drive the modules. That is, when the user input (for example, photograph, transmit, and store) is received by the key input unit formed in the flexible apparatus 20 with a photographing module, the control module 10 may generate corresponding commands. For example, a signal regarding “photograph” is input through the key input unit, the control module 10 may photograph a subject by the photographing module 11, which will be described below with reference to FIG. 2.

According to the additional exemplary embodiment, the control module 10 may further include a speed detecting module 15. The control module 10 controls the photographing module 11 to adjust a shutter value, a resolution, and the number of continuous photographing in accordance with the speed detected by the speed detecting module 15.

Additionally, a photographing method is set in advance in accordance with the speed, so that when the speed is detected by the speed detecting module 15, the photographing module 11 may photograph a subject based on predetermined information.

Moreover, the flexible apparatus 20 with a photographing module may further include the charging module 17 to charge the photographing module 11 and/or the control module 10.

The charging module 17 may include at least one of an internal battery and an external battery. Further, the internal battery may be charged wirely and/or wirelessly. Further, the charging module 17 may further include an auxiliary battery. For example, when the internal battery is employed to charge the photographing module 11, the external battery may be employed as an auxiliary battery.

More specifically, the charging module 17 may include at least one of an external battery, an internal circuit which charges the photographing module 11 at the time of supplying power and an internal circuit which is provided in the photographing module 11 to wirelessly charge the photographing module 11.

Further, sine the flexible apparatus 20 with a photographing module may be deformed when force is applied to the apparatus, a flexible battery which is deformed together with the flexible body 25 may be used as the charging modules. A tiny pin battery may be used. Selectively or alternatively, a curved battery may be used.

Additionally, when the external battery is employed in one area of the flexible body, a battery cover which is formed to be opened/closed to exchange the battery may be provided. Furthermore, the battery cover may further include a joint groove to be easily opened/closed. Whether to provide the charging battery cover may be determined in accordance with a charging method of the photographing module 11. For example, when the charging module 17 is connected to a jack to be charged from the outside, an external battery accommodating unit and an external battery cover may be replaced with one charging unit or a charging circuit.

According to the exemplary embodiment of the present invention, the charging module 17 may include a charging connection terminal to charge the photographing module 11. Further, when only a wireless charging method is employed as a charging method of the charging module 17, the charging connection terminal may be omitted.

In an additional aspect of the present invention, the charging module 17 may be formed in a specific position of the flexible body in accordance with a design specification of the flexible apparatus. For example, the charging module 17 may be formed at least one of internal spaces of the flexible body. According to an additional exemplary embodiment of the present invention, the charging module 17 may be located in the photographing module 11.

Furthermore, an LED lamp which confirms whether to be charged may be located in one area of the flexible body. That is, a module which checks a charging state of at least one of the flexible body and the photographing module may be included. An LED lamp may be selected as the module. Further, the charging state may be confirmed by a color of the LED lamp. For example, when the color of the LED lamp is green, it indicates that the battery is fully charged, when the color of the LED lamp is blue, it indicates that the battery is being charged, and when the color of the LED lamp is red, it indicates that the battery needs to be charged.

The above-described modules are only examples according to the exemplary embodiment of the present invention and a flexible apparatus 20 which includes more photographing modules or less photographing modules than the modules illustrated in FIG. 1 may be implemented.

For example, a display module (not illustrated) which outputs an image photographed by at least one photographing module 11 may be further provided. Further, the display module may be formed to be integrally modified with the flexible body. Alternatively, the display module may be formed as a rigid body which is not modified integrally with the flexible body to pivot around the flexible body. Further, the display module may be configured to be separated from the flexible body to modify the flexible body.

Further, the display module is provided at a rear surface of the flexible body to output an image formed by at least one photographing module 11. The display module may be formed to be integrally modified with the flexible apparatus 20. To this end, a flexible display substrate may be employed as the display module. For example, at least one of steel, polyimide, polyetheretherketon (PEEK), polyethersulfone (PES), polyetherimide (PEI), polycarbonate (PC), polyethylenenapthalate (PEN), and polyester (PET) may be employed.

A display module according to an additional exemplary embodiment may be formed so as not to be integrally modified with the flexible apparatus 20. That is, a display module which is formed of a rigid body like the display module of the related art may be used as the display module.

The control module 10 is provided in the flexible apparatus 20 with a photographing module to control at least one photographing module 11 to photograph a subject and store at least one image. The control module 10 may be configured by lots of electronic components such as a driver IC, ASIC, and a memory to control the photographing module 11, the storing module 12, the communication module 13, the voice control module 14, the speed detecting module 15, the motion module 16, and the charging module 17. The above-described modules are only examples according to an exemplary embodiment of the present invention and more or less modules may be provided.

Further, the control module 10 is formed by assembling the electronic components on a flexible printed circuit board to be integrally modified when the flexible body 25 is modified. Further, a protective film may be attached on a rear surface of the control module 10 to protect the control module 10. Otherwise, a protective layer may be formed to protect the control module 10.

Various exemplary embodiments described in the specification may be implemented in a recording medium or a storage medium which may be read by a computer or a similar device, for example, using software, hardware, or a combination thereof.

For example, according to a hardware implementation, the exemplary embodiment described in the specification may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units which perform other functions. In some cases, the exemplary embodiments described in the specification may be implemented by the control module 10.

As another example, according to a software implementation, exemplary embodiments described in the specification such as procedures and functions may be implemented by separate software modules. The software modules may perform one or more functions or operations which are described in the specification. A software code may be implemented by a software application written by appropriate program language. The software code is stored in the storing module 12 and executed by the control module 10.

FIG. 2A illustrates a flexible apparatus with a photographing module according to an exemplary embodiment of the present invention.

FIG. 2B illustrates a flexible apparatus with a photographing module according to an exemplary embodiment of the present invention and a detachable housing.

A flexible apparatus 20 with a photographing module according to an exemplary embodiment of the present invention may be configured by a photographing module 21, a housing 23, and a flexible body 25.

At least one of a camera and a camcorder may be selected as the photographing module 11. That is, various commercially used cameras and camcorders may be employed as the photographing module 11. For example, a high pixel mega level camera may be used as the photographing module 11. Otherwise, a low pixel VGA level camera may be employed. Furthermore, the photographing module 11 may be replaced from the flexible body.

The housing 23 according to the additional exemplary embodiment of the present invention may be coupled to an end of the flexible body 25, as illustrated in FIG. 2A. The housing 23 accommodates at least a part of the photographing module 11 and covers at least an upper surface of the photographing module 11 to protect the photographing module 11. By doing this, the photographing module 21 is supported by the flexible body 25 and the housing 23 and protected from external impact.

Additionally, at least a part of the housing 23 may be formed of a waterproof material to protect the photographing module 11 from external moisture. For example, a part of the housing may be configured by plastic having high light transmittance.

According to the additional exemplary embodiment of the present invention, as illustrated in FIG. 2B, at least a part of the housing 23 is separated to be detachable from at least one of the photographing module 11 and the flexible body 25. Therefore, as illustrated in FIG. 2B, the housing 23 may be replaced with various shapes of housings 23 in accordance with a preference of the user so that aesthetic impression may be increased.

According to the additional exemplary embodiment of the present invention, the housing 23 may further include a lens which is coupled to at least a part of the housing 23. Further, the lens may be detachable from the housing 23. That is, an arrangement of the lens and a focal distance of the lens may be modified.

According to an exemplary embodiment of the present invention, at least one of an aspherical lens and a spherical lens may be employed as the lens. Further, a plurality of lenses may be employed to compensate hand shaking.

In other words, a lens accommodating unit or a lens fixing unit into which the lens is inserted may be formed at a part of the housing 23. Therefore, various shapes of lenses (for example, a wide angle lens or a telephoto mode) are inserted or removed in accordance with the preference of the user to perform the photographing in various modes.

For example, the housing 23 has a 11 or II shape in which a bottom part is open. Therefore, when the housing 23 is coupled to the upper end of the flexible body 25, the lens module is exposed to the outside. In this case, individual lenses may be attached or detached to or from the lower side of the housing 23, so that when the housing 23 is coupled to the flexible body 25, an additional lens may be located in front of the lens module.

As another example, different lenses may be formed to be fixed to the housing 23. Referring to FIG. 2B, for example, a cat shaped housing among the detached housings 23 includes a wide angle lens and a bear shaped housing includes a telephoto lens. By doing this, a housing including various lenses in accordance with needs of the user may be attached or detached. By doing this, the photographing may be performed in various modes. The above description is only an example according to the exemplary embodiment of the present invention and at least one of the colors, the shapes, and the materials of different housings 23 having different lenses may vary to distinguish the housings.

The housing 23 as described above may be formed of the same material as the flexible body 25 or formed of a different material from the flexible body.

For example, the housing 23 may be formed of a material having flexibility which is integrally modified with the flexible body 25. Therefore, the housing 23 may be formed of plastic or a metal having flexibility.

As another example, the housing 23 may be configured by an elastic member having elasticity. The elastic member may include a synthetic resin having elasticity such as polyvinylacetate, polyurethane, a rubber, or silicon. Further, the housing may be plastic and/or metal. For example, the housing may include polyamide resin, polyphenylene oxide, or acetal resin.

Furthermore, the housing 23 may further have a function which protects components configured in the photographing module and blocks an electromagnetic wave noise therein.

Even though not illustrated, a flash module housing which is formed to accommodate the flash module may be coupled to the housing 23. Here, the flash module housing may be formed to have a box shape whose upper and lower sides are open to accommodate the flash module. Further, the flash module housing may be at least one of a thermosetting plastic such as phenol resin, urea resin, melanin resin, unsaturated polyester resin, and epoxy resin and a thermoplastic plastic such as polyethylene, polypropylene, polyvinyl chloride, polyamide nylon, polycarbonate (PC), polyacetal, and polyphenylene sulfide. For example, the flash module housing may be formed of a polycarbonate plastic. Or, the flash module housing may be formed of a liquid crystal polymer plastic.

The flexible body 25 may further include a handle. The handle may be located at one end of the flexible body 25. Further, as illustrated in the drawing, in the flexible apparatus 20 with a photographing module, areas of both ends of the flexible body 25 may be larger than an area of a middle part of the flexible body 25.

According to the additional exemplary embodiment of the present invention, the key input unit 27 may be located in one region of the flexible body 25. As illustrated in the drawing, the key input unit 27 may be located at a lower end (for example, the handle) of the flexible body 25. As another example, the key input unit 27 may be formed in a remote controller which communicates with the communication module 13. Furthermore, the key input unit may correspond to a user input module (not illustrated, for example, a touch pad, a microphone, and a keyboard) of an external device which communicates with the communication module 13.

The key input unit 27 may be provided to be at least one of a soft key input unit and a physical key input unit. That is, an image is input by touching a display or an operation corresponding to the input operation may be performed by pressing a key. For example, when a pressure which exceeds a predetermined reference is detected from the physical key input unit which receives an input of “store an image”, the photographed image may be stored. Further, when a touch gesture is detected as a tap for “delete a stored image”, the stored image may be deleted.

Further, as described above, the key input unit 27 may be at least one of a touch pad, a key pad, a mouse, a switch, and a keyboard of an external device (not illustrated) which communicates with the flexible apparatus 20 with a photographing module. Further, the key input unit may be a voice input device such as a microphone.

When the key input unit is a voice input device, the photographing module 11 may be controlled by the above-described voice control module 14. Further, the voice command is set by the voice control module 14 and the photographing module 11 is controlled based on the set voice command. For example, when a voice command of “photograph” is received, the photographing module 11 photographs a subject and when a voice command of “store” is received, stores one or more photographed images.

Additionally, the voice control module 14 decodes at least two voice command signals to control the photographing module 11 based on continuously received voice commands. That is, when voice commands of “store after photographing”, “photograph and store”, “photograph and store”, and “please, photograph and store” are received, the photographing module 11 recognizes a combination (that is, predetermined voice commands “photograph” and “store”) of received voice commands to simultaneously photograph a subject and store the photographed image.

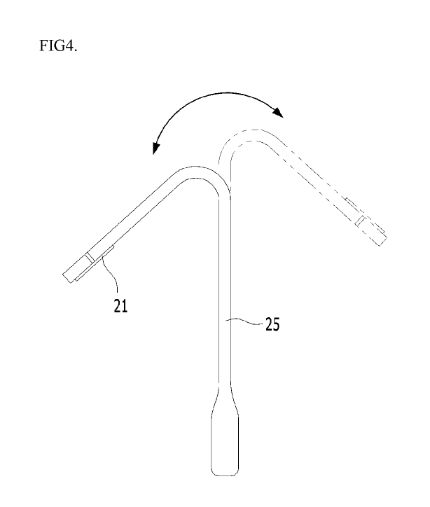

The flexible body 25 according to an exemplary embodiment of the present invention may be formed to be freely modified, for example, be bent or twisted. For example, when force is applied to at least the left and right of the flexible body 25 illustrated in FIG. 2, the flexible body 25 may be modified as illustrated in FIGS. 3A and 3B. Further, when force is applied to the flexible body 25, as illustrated in FIG. 4, the flexible body 25 may be bent at a predetermined curvature so as to be convex or concave. Further, when force is longitudinally applied to the flexible body 15, a part of the flexible body 25 may extend or be shortened in a height direction. Further, the flexible body 25 may be formed to easily return to the original state after being modified. For example, the flexible body 25 may be formed of a flexible polymer material such as poly dimethyl silicone (PDMS).

Further, the flexible body 25 may be formed of a material having a property which maintains a modified state. Therefore, after the shape of the flexible body 25 is modified by applying predetermined force to the flexible body 25, even though the force is removed, the flexible body 25 may maintain the modified shape.

As described above, the flexible body 25 may be formed to support and accommodate at least one photographing module 21 and be modified by applying predetermined force. Further, the flexible body 25 includes the storing module 12, the communication module 13, and the control module 10 and is integrally formed, so that when force is applied, a shape of the flexible body 25 is modified and the modified state is maintained even though the force is removed, which will be described with reference to FIGS. 3, 4, and 5.

According to the additional exemplary embodiment of the present invention, the flexible body 25 may further include the key input unit 27. The key input unit 27 may be formed at one end surface of the flexible body 25. For example, the key input unit may be formed at a lower end of the flexible body 25 as illustrated in the drawing or formed in a middle part of the flexible body 25.

Further, a driving unit (not illustrated) which automatically modifies the housing may be provided in the flexible body 25. The driving unit according to an exemplary embodiment of the present invention may be formed to automatically bend the flexible body 25 with a predetermined curvature in accordance with a setting of the user. Therefore, the user does not need to directly bend the flexible body 25 by hands. The driving unit may be formed of an electroactive polymer, a piezoelectric material, or a shape memory alloy which applies force to the flexible body 25 to modify the flexible body 25. Further, the driving unit may be formed to have a motor driving structure which modifies the flexible body 20.

In one aspect of the present invention, a module opening which exposes the module such as the key input unit to the outside may be formed at one end of the flexible body 25. Further, the flexible body 25 may include an opening for an external terminal to be connected with the external terminal such as a charger terminal and/or a USB terminal.

As described above, the flexible apparatus 20 with a photographing module may include the flexible body which is modified when force is applied but maintains the modified state even though the force is removed. Therefore, the flexible apparatus 20 may be bent or stretched in accordance with a direction of the force.

FIG. 3A illustrates an exemplary shape of a rotating operation of a flexible apparatus with a photographing module according to an exemplary embodiment of the present invention.

FIG. 3B illustrates an exemplary shape of a rotating operation of a flexible apparatus with a photographing module according to another exemplary embodiment of the present invention.

Referring to FIGS. 3A and 3B, when force is applied to left and right of the flexible body 25, the flexible body 25 rotates in a direction where the force is applied.

FIG. 4 illustrates an exemplary shape of a bending operation of a flexible apparatus with a photographing module according to an exemplary embodiment of the present invention. That is, when force is applied to the flexible body 25, the flexible body 25 may be bent to be convex or concave in a direction where the force is applied.

That is, the flexible apparatus 20 with a photographing module may perform a rotating and/or bending operation so as to photograph a subject at various compositions.

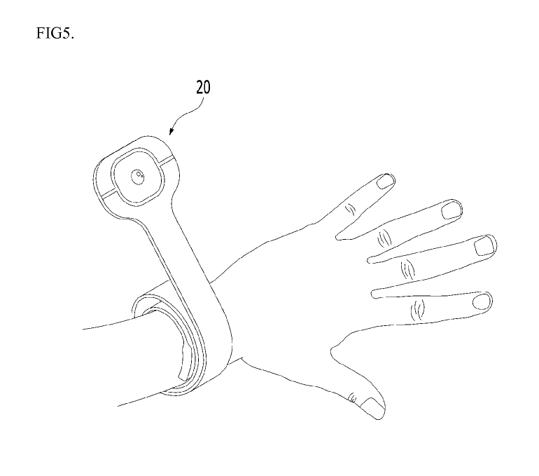

FIG. 5 illustrates a flexible apparatus with a photographing module according to an exemplary embodiment of the present invention which is put on the wrist.

Referring to FIG. 5, the flexible apparatus 20 with a photographing module may be worn around a wrist due to a characteristic of the flexible body described above. To this end, an additional accessary (for example, an auxiliary device which more strongly fastens the device to the wrist) may be provided.

According to an exemplary embodiment of the present invention, the user may photograph a subject while enjoying an activity such as bicycle or climbing through the flexible apparatus 20 with a photographing module. For example, the flexible apparatus 20 allows the user to photograph the views while riding a bicycle. Further, the flexible apparatus allows the user to photograph a face of the user while dancing.

Further, as illustrated in the drawing, the flexible apparatus 20 with a photographing module may be twisted to be rolled up or bent or curved to be easily carried. Further, the flexible apparatus 20 photographs the subject at various compositions.

As another example, the flexible apparatus 20 with a photographing module may be bent or curved as described above, so as to further include a function of a belt, thereby enhancing portability and functionality. To this end, a joint unit which fixes the apparatus may be further provided at both ends of the flexible apparatus 20 with a photographing module. For example, a joint protrusion is formed at a part of the housing and a joint groove is formed at a part of the handle. Further, a magnetic is formed in the flexible apparatus 20 so that both ends of the flexible apparatus may be fixed without having a separate joint unit.

Those skilled in the art may understand that information and signals may be expressed using various arbitrary technologies and techniques. For example, data, instructions, commands, information, signals, bits, symbols, and chips which may be referred in the above description may be expressed by voltages, currents, electromagnetic waves, magnetic fields, or particles, optical fields, or particles, or an arbitrary combination thoseof.

Those skilled in the art may understand that various exemplary logic blocks, modules, processors, means, circuits, and algorithm steps described with reference to the exemplary embodiments disclosed herein may be implemented by being combined with electronic hardware, various types of programs (here, referred to as software for the purpose of convenience) or a design code or a combination thoseof. In order to clearly describe the compatibility of the hardware and the software, various exemplary components, blocks, modules, circuits, and steps are generally described above with respect to functions thereof. Whether the function is implemented as the hardware or software depends on design restrictions which are assigned to a specific application and an entire system. Those skilled in the art may implement the described function of a specific application by various methods but decision of the implement needs to be interpreted that it does not depart from the scope of the present invention.

Various exemplary embodiments suggested herein may be implemented by articles manufactured using a method, an apparatus, or a standard programing and/or engineering technology. A terminology of “manufactured article” includes a computer program, a carrier, or a medium which is accessed from an arbitrary computer readable device. For example, the computer readable medium includes a magnetic storing device (for example, a hard disk, a floppy disk, or a magnetic strip), an optical disk (for example, CD or DVD), a smart card, and a flash memory device (for example, an EEPROM, a card, a stick, and a key drive), but is not limited thereto. Further, various storage media suggested herein include one or more devices for storing information and/or other machine readable media. A terminology of “machine readable medium” includes a wireless channel which stores, holds, and/or transmits commands and/or data and various other media, but are not limited thereto.

It should be understood that a specific order or a hierarchical structure of steps in suggested processes are examples of exemplary approaches. It should be understood that a specific order or a hierarchical structure of steps in processes may be rearranged based on a design priority within the scope of the present invention. Accompanying method claims provide elements of various steps in the order of samples, but are not limited to the suggested specific order or hierarchical structure.

Description of the suggested exemplary embodiments is provided so that those skilled in the art use or carry out the present invention. Various modifications of the exemplary embodiment are obvious to those skilled in the art and general principles defined herein may be applied to other exemplary embodiments without departing from the scope of the present invention. Therefore, the present invention is not limited to the suggested exemplary embodiment, but interpreted in the broadest scope consistent with the principles suggested herein and new features.

### MODE FOR CARRYING OUT THE INVENTION

As described above, related contents have been described in the best mode for carrying out the present invention.

### INDUSTRIAL APPLICABILITY

The present invention may be used for a flexible apparatus, portable electronic equipment, a photographing device such as a camera or a camcorder, a communication device, a charging device, an accessary, or sport goods.

1. A flexible apparatus with a photographing module, comprising:
one or more photographing modules which photograph an image (including a still image and a moving image) of a subject;
a storing module which stores one or more images photographed by the photographing module;
a communication module which transmits the one or more images to an external device to display the one or more images photographed by the photographing modules on the external device;
a control module which generates commands for driving the photographing module, the storing module, and the communication module;
a flexible body which includes the photographing module, the storing module, the communication module, and the control module and is integrally formed, so that when force is applied, the flexible body is modified and the modified state is maintained even though the force is removed; and
a housing which accommodates the photographing module, covers at least an upper surface of the photographing module to protect the photographing module, and is coupled to one end of the flexible body.

2. The flexible apparatus of claim 1, wherein a part of the housing is separated to be detachable from at least one of the photographing module and the flexible body.

3. The flexible apparatus of claim 2, wherein the housing further includes a lens which is coupled to at least a part of the housing and the lens is detachable from the housing.

4. The flexible apparatus of claim 2, wherein at least a part of the housing is formed of a waterproof material to protect the photographing module.

5. The flexible apparatus of claim 1, wherein the photographing module further includes an optical image stabilizer (OIS) module which moves a lens in accordance with movement of a camera similar to eyes of a human being to automatically adjust a focus.

6. The flexible apparatus of claim 1, wherein the photographing module further includes an auto focus actuator (AFA) module to adjust a focus.

7. The flexible apparatus of claim 1, wherein the photographing module further includes a flash module which emits light in order to illuminate surroundings when an image is photographed through the photographing module.

8. The flexible apparatus of claim 1, wherein the photographing module includes at least one function of an ISO adjusting function, a resolution adjusting function, an out of focus function, a mechanical shutter, and a zooming function.

9. The flexible apparatus of claim 1, wherein the storing module includes at least one of a flash memory type, an SD memory, an XD memory, a magnetic memory, and a magnetic disc.

10. The flexible apparatus of claim 1, wherein the communication module includes at least one of a short range communication module and a wireless communication module and transmits/receives data by the photographing module, the storing module, and the external device.

11. The flexible apparatus of claim 1, wherein the communication module transmits one or more images photographed by the photographing module to the external device so that the one or more images are streamed in the external device.

12. The flexible apparatus of claim 1, wherein the communication module transmits one or more images which are photographed by the photographing module to at least one of an external device and an external server which are automatically determined in advance in the unit of a predetermined period.

13. The flexible apparatus of claim 1, wherein the control module controls the photographing module to perform continuous photographing, panoramic photographing, surround photographing, three-dimensional stereography, and close-up photographing.

14. The flexible apparatus of claim 1, wherein the control module controls at least one of an operating direction and an operating speed of the flexible body.

15. The flexible apparatus of claim 1, wherein the control module further includes a voice control module which detects a voice command signal in accordance with a predetermined voice command to drive the modules in accordance with the command and the voice command is set and detected by a voice input unit which is provided in the photographing module and the external device.

16. The flexible apparatus of claim 1, wherein the control module further includes a motion module which controls an operating direction and an operating speed of the flexible body and the photographing module to bend and/or rotate the flexible body.

17. The flexible apparatus of claim 1, wherein the control module further includes a key input unit which receives a user input to drive the modules.

18. The flexible apparatus of claim 17, wherein the key input unit is formed on one end surface of the flexible body.

19. The flexible apparatus of claim 17, wherein the key input unit is formed in a remote controller which communicates with the communication module.

20. The flexible apparatus of claim 17, wherein the key input unit corresponds to a user input unit of an external device which communicates with the communication module.

21. The flexible apparatus of claim 17, wherein the key input unit is provided as at least one of a soft key input unit and a physical key input unit.

22. The flexible apparatus of claim 1, wherein the flexible body further includes a speed detecting module which detects a speed of the subject, and the control module automatically controls the lens and the photographing module in accordance with the speed of the subject detected by the speed detecting module.

23. The flexible apparatus of claim 1, wherein the flexible body further includes a handle which is located at one end of the flexible body.

24. The flexible apparatus of claim 1, wherein an area of both ends of the flexible body is larger than an area of a middle part of the flexible body.

25. The flexible apparatus of claim 1, further comprising:
a charging module which charges the photographing module.

26. The flexible apparatus of claim 25, wherein the charging module includes at least one of an internal battery and an external battery which are wirely and/or wirelessly charged.
